(19) United States
(12) Patent Application Publication
(10) Pub. No.: US 2009/0036322 A1
(43) Pub. Date: Feb. 5, 2009

(54) Leukocyte Adsorbing Material

(75) Inventors: Mark Bradley, Edinburgh (GB); Junichi Shishido, Tokyo (JP); Jean-Francois Thaburet, Yerville (FR)

Correspondence Address: MERCHANT & GOULD PC, P.O. BOX 2903, MINNEAPOLIS, MN, 55402-0903, US

(73) Assignee: University of Southhampton, Highfield (GB)

(21) Appl. No.: 11/597,586

(22) PCT Filed: May 18, 2005
(86) PCT No.: PCT/GB05/01927

§ 371 Date: Mar. 27, 2008

(30) Foreign Application Priority Data
May 20, 2004 (GB) 0411259.5

(51) Int. Cl. C40B 30/04; C08G 18/73; C08G 18/75

(52) U.S. Cl. 506/9; 528/367

(57) ABSTRACT

A novel polyurethane material having excellent leukocyte adsorption capacity. When exposed to a labelled sugar chain solution LDF1 for 2 hours, it exhibits an adsorption amount of 400,000 or more. The polyurethane is composed of (A) a diisocyanate compound structural unit, (B) a polymer diol compound structural unit, and (C) a chain extender structural unit, preferably containing a tertiary amino group.

### FIELD OF THE INVENTION

The present invention relates to a leukocyte adsorbing material composed of polyurethane. The leukocyte adsorbing material of the present invention is formed into a single formed body or a composite applied to a water insoluble carrier by coating or a graft reaction, and can be used for medical devices and various types of laboratory instrument for medical care or medical science which require adsorbing a large amount of leukocytes, particularly for a leukocyte-removing filter for blood transfusion.

### BACKGROUND ART

Recently, in Europe, U.S.A. and Japan, leukocytes are removed from transfusion blood in order to reduce various serious side effects including a graft versus host reaction (GVHD) caused by leukocytes contained in transfusion preparations. Among the methods for removing leukocyte, a method using so-called leukocyte-removing filter is typically used.

Furthermore, recently in Europe, there is a concern that abnormal prions, which are considered to cause bovine spongy encephalopathy, may be present in the human blood which was collected by blood donation for transfusion. It has been strongly recommended that a leukocyte-removing filter should be used for transfusion blood in view of removing abnormal prions from the leukocytes.

As a result, the market of leukocyte-removing filters has been expanded more and more.

Under such circumstances, researchers of the art have a hot race for developing a leukocyte-removing filter. Typical of leukocyte-removing filters presently in use is a filter using non-woven polyester. A thin polyester fiber can highly adsorb leukocytes, and the filter uses this characteristic. Recently, improvement of the efficacy of leukocyte removal and reduction of the cost, have been required. To satisfy these requirements, the possibility of applying an appropriate processing to a conventional non-woven polyester has been studied.

Such processing methods are broadly classified into two categories. One is to use non-woven cloth of thinner fibers as illustrated in JP Patent Publication (Kokai) No. 11-9687; an approach of physically modifying the structure of fibers. The other is to chemically modify the surface of fibers, thereby improving the affinity to leukocytes; an approach of chemically modifying the surface of fibers. Of course, the possibility of using both approaches in combination has been studied.

Recently, the latter case, that is, the surface chemical modification approach, particularly has received attention. More specifically, a method of applying a polymer having specifically high affinity to leukocytes onto the surface of fibers constituting non-woven cloth is studied. By way of an example, JP patent Publication (Kokai) No. 2001-310917 discloses a leukocyte removing filter having, at least on the surface of a filter base, a graft or block copolymer which has a polymer segment composed of monomers having a nonionic hydrophilic group and a polymer segment composed of monomers having a basic nitrogen-containing functional group. However, these conventional methods have problems that: a special polymer having a specifically high affinity to leukocytes must be synthesized, and the polymer thus synthesized is expensive as a material for a leukocyte-removing filter.

In medical tools, especially, medical devices used for treating cardiovascular disorders, more specifically, as polymer materials for an artificial blood vessel and an artificial heart, a polyurethane polymer is typically used. Polyurethane has advantages for manufacturing and processing in that it is inexpensive and easy to synthesize and form. In addition to such advantages, polyurethane has structural advantages in that it has necessary and sufficient strength and flexibility. Furthermore, since the surface of polyurethane has low affinity to blood cells, thrombus is unlikely to form. Polyurethane is thus an excellent material.

There is a leukocyte-removing filter product utilizing a porous film structure composed of polyurethane. It takes advantage of a characteristic of polyurethane that it is easy to foam to form a porous film structure having a highly-controlled pore size, allowing physical capture of leukocytes by its size exclusion (sieve) effect. As a result, in order to capture lymphocytes (extremely small leukocytes) well, it must have an extremely small average pore diameter. Therefore, this product is not sufficient with respect to the compatibility of leukocyte-removing capability and prevention of channel-clogging. In brief, the leukocyte-removing filter product utilizing a porous film structure composed of polyurethane does not have an excellent leukocyte adsorption capacity on its surface. In fact, the researchers who developed this product described that since polyurethane generally has poor interaction with cells, the porous film structure of the leukocyte-removing filter was designed so as to achieve high leukocyte-removing capability by a physical sieving effect (Cells, Vol. 34, No. 11, Page 28, 2002).

As is apparent from the above, it has been widely known to those in the art that the blood cell adsorption capacity of polyurethane is generally low, and naturally it has also been widely recognized that the leukocyte adsorption capacity of polyurethane is low.

From the above, it cannot be easily anticipated that the surface itself of polyurethane having a particular composition has a sufficient affinity to the leukocytes which is required for a product. Needless to say, industrial use of such affinity is unconceivable for those skilled in the art.

Recently, when a complex system (multiple factors affect the results in a complexed manner) is studied, a combinatorial chemistry approach is sometimes used in place of a conventional deductive approach. The combinatorial chemistry approach, in which an extremely increased number of experiments are performed for novel findings, has been so far used principally in the field of drug design. Recently, this approach has been used in increasingly many areas, and even applied to synthesizing and screening functional materials such as a functional dye used in organic EL material and a dendrimer.

There have been attempts to understand physical properties by the combinatorial chemical approach. Among them, a study on the interaction between a synthetic polymer and a biological substance has been reported in WO 95-34813 (JP Patent Publication (Kohyo) No. 10-502102). However, this document does not get further into the really practical correlation with physical properties in respect to understanding physical properties from the viewpoint of biocompatibility.

### SUMMARY OF THE INVENTION

An object of the present invention is to provide a novel material composed of polyurethane having an excellent leukocyte adsorption capacity in itself.

The present inventors have made an extensive investigation to understand physical properties by a combinatorial chemistry approach. Particularly, the present inventors have investigated the interaction between a biological substance and a surface of a material, and more specifically, the interaction between leukocytes and a labeled sugar chain solution having high affinity to the leukocytes. As a result, they have found that polyurethane exhibits high affinity to leukocytes by appropriately formulating it in a specific composition range, although the affinity of polyurethane to various biological materials including blood cells has been so far considered to be low. They have found also that the leukocyte adsorption capacity of a leukocyte-removing filter manufactured with a composition in the range is high enough for the filter to be put in practical use. Based on these finding, the present invention was completed.

Thus, the present invention provides a leukocyte adsorbing material composed of polyurethane which exhibits an adsorption amount of 400,000 or more after being exposed to a labeled sugar chain solution (LDF1) for 2 hours.

Preferably, the polyurethane is represented by the following formula (1):

[AₗBₘC] (1)

wherein (A), (B) and (C) are structural units which constitutes the polyurethane:
(A): a diisocyanate compound structural unit, which may be one or more types,
(B): a polymer diol compound structural unit, which may be one or more types, and
(C): a chain extender structural unit, which may be one or more types, with the proviso that a weight-average molecular weight of the polyurethane is more than 20,000 and not more than 1,000,000; and

l, m and n represent mol % of the structural units (A), (B), and (C), respectively, and satisfy the relations:

l+m+n=100

0.9≦l/(m+n)≦1.25, and

0≦n≦40

Preferably, the diisocyanate compound structural unit is derived from aliphatic diisocyanate compound.

Preferably, the diisocyanate compound structural unit is derived from hexamethylene diisocyanate and/or 1,3-bis(isocyanatemethyl)cyclohexane.

Preferably, the chain extender is one containing a tertiary amino group.

### BRIEF DESCRIPTION OF THE DRAWINGS

FIG. 1 is a graph showing the correlation between the leukocyte removing capability obtained by blood analysis and the LDF1 adsorption amount determined by a microarray method, for the polyurethanes obtained in the Examples and Comparative Examples. In the figure, an R.PLT value represents a blood platelet leakage percentage (%) of each of the Examples and Comparative Examples in the blood analysis.

### DETAILED DESCRIPTION OF THE INVENTION

The present invention will now be described in detail below.

As used herein, a polyurethane is a polymer obtained by condensation polymerization of a diisocyanate compound and a diol compound, whose main chain has a urethane structure formed by reaction of an isocyanate group and a hydroxyl group.

As used herein, a diisocyanate compound is a compound having two isocyanate groups in its molecule. Diisocyanate compounds of a high molecular weight which have isocyanate groups at both ends of the linear polymer are also included. Such a diisocyanate compound may be used singly or in combination of two or more types as necessary.

Specific examples of such a diisocyanate compound include hexamethylene diisocyanate, 1,3-bis(isocyanatemethyl)cyclohexane, 4,4-methylene bis(cyclohexylisocyanate), 1,4-phenylene diisocyanate, (4-methyl-1,3-phenylene diisocyanate), 1,4-cyclohexadiisocyanate, isophorone disocyanate, trimethyl hexamethylene diisocyanate, and diisocyanates of dimer acids.

Among them, hexamethylene diisocyanate and 1,3-bis(isocyanatemethyl)cyclohexane are particularly preferable.

As used herein, a diol compound is a compound having two hydroxyl groups in the molecule, and includes a low molecular-weight diol compound and a polymer diol compound having hydroxyl groups at both ends of the linear polymer. Such a diol compound may be used singly or in combination of two or more types as necessary.

Specific examples of such a low molecular-weight diol compound include ethylene glycol, propane diol, 1,2-butane diol, 1,3-butane diol, 1,4-butane diol, 1,5-pentane diol, 2,4-pentane diol, 1,2-hexane diol, 1,6-hexane diol, 2,5-hexane diol, 1,4-cyclohexane diol, 1,2-cyclohexane diol, 1,7-heptane diol, 1,8-octane diol, and neopentyl glycol.

Specific examples of such a polymer diol compound include polyethylene glycol, polypropylene glycol, polytetramethylene glycol, poly(ethylene glycol/propylene glycol)copolymer, poly(ethylene glycol/tetramethylene glycol)copolymer, poly(propylene glycol/tetramethylene glycol)copolymer, poly(ethylene glycol/propylene glycol/tetramethylene glycol)copolymer, poly[1,6-hexanediol/neopentyl glycol/di(ethylene glycol)-alt-adipic acid]diol, polybutylene terephthalate having hydroxyl groups at both ends, polystyrene and polystyrene copolymer having hydroxyl groups at both ends, polymethyl (meth)acrylate and polymethyl(meth)acrylate copolymer having hydroxyl groups at both ends, polyacrylamide and polyacrylamide copolymer having hydroxyl groups at both ends, poly N,N-dimethyl acrylamide and poly N,N-dimethyl acrylamide copolymer having hydroxyl groups at both ends, poly N,N-diethyl acrylamide and poly N,N-diethyl acrylamide copolymer having hydroxyl groups at both ends, polymethoxyethylene (meth)acrylate and polymethoxyethylene (meth)acrylate copolymer having hydroxyl groups at both ends, polyvinyl pyrrolidone and polyvinyl pyrrolidone copolymer having hydroxyl groups at both ends.

As the diol compound to be used in polyurethane polymerization according to the present invention, in particular, it is desired to use a polymer diol compound. By use of the polymer diol compound, it is possible to obtain polyurethane having a surface structure composed of two discrete phases: one is a diol compound structural unit imparting an appropriate surface hydrophobic property and the other is an isocyanate compound structural unit imparting an appropriate surface hydrophilic property, with the result that its leukocyte adsorption capacity can be improved.

The number-average molecular weight of the polymer diol compound is desirably equal to or more than 200 and not more than 10,000. If the number-average molecular weight falls within this range, the phases of the polymer diol compound structural unit and the diisocyanate compound structural unit can be sufficiently separated. More preferably, the number-average molecular weight of the polymer diol compound is equal to or more than 200 and not more than 5,000, and most preferably, equal to or more than 200 and not more than 2,000.

In order to impart an appropriate hydrophobic property to the surface of polyurethane, a polymer diol compound according to the present invention preferably has an appropriate Y/X value, where X is defined as the number of carbons forming the main chain of the polymer diol and Y is defined as the number of hetero atoms forming the main chain, such as nitrogen, oxygen, sulfur, and silicon. A preferable Y/X value is equal to or more than 0 and not more than 2. If the Y/X value falls within this range, an appropriate surface hydrophobic property can be obtained, thereby improving leukocyte adsorption capacity. More preferably, the Y/X value is equal to or more than 0 and not more than 0.35, and particularly preferably, equal to or more than 0 and not more than 0.25.

As used herein, a chain extender is a compound having two or more functional groups such as a hydroxyl group, amino group, mercapto group or epoxy group which react with an isocyanate group, in its molecule. Specific examples of such a chain extender include 1,4-butanediol, ethylenediamine, 1,4-butanethiol, ethylene glycol diglycydylether, 3-(dimethylethylamino)-1,2-propanediol, 3-(diethylethylamino)-1,2-propanediol, 2,2,3,3,4,4,5,5-octafluoro-1,6-hexanediol, and bis(hydroxymethyl)diethyl malonate. They are used singly or in combination of two or more types. By using a chain extender during postprocessing, polyurethane according to the present invention can be successfully polymerized and cross-linked.

As a chain extender used in the present invention, it is desirable to use a compound having two or more hydroxyl groups, amino groups and/or mercapto groups which can react with an isocyanate group, and one or more tertiary amino groups in its molecule.

As used herein, the tertiary amino group in a chain extender is one having a structure represented by the following formula (2) in which a hydrogen atom of the amino group is substituted by functional groups R¹ and R² containing 1 to 6 carbon atoms.

—NR¹R² (2)

wherein R¹ and R² may be the same or different.

Specific examples of R¹ and R² include methyl group, ethyl group, n-propyl group, iso-propyl group, n-butyl group, tert-butyl group, n-pentyl group, n-hexyl group, cyclohexyl group, hydroxyethyl group, and methoxyethyl group.

Specific examples of the chain extender having a tertiary amino acid include 3-(dimethylethylamino)-1,2-propanediol, and 3-(diethylethylamino)-1,2-propanediol. By use of the chain extenders having a tertiary amino acid, the surface of polyurethane can be appropriately charged positively, thereby facilitating the removal of electrostatically negatively charged leukocytes.

A desirable weight-average molecular weight of the polyurethane in the present invention is equal to or more than 20,000 and not more than 1,000,000. If the weight-average molecular weight is 20,000 or more, the solubility of such a polyurethane in water is sufficiently low. This property is preferable from a safety point of view. In contrast, if the weight-average molecular weight is not more than 1,000,000, the viscosity of the polyurethane is low. This property is preferable since it can make easy the handling of the polyurethane during synthesis. More preferably, the weight-average molecular weight is equal to or more than 25,000 and not more than 500,000, and most preferably, equal to or more than 25,000 and not more than 300,000.

Now, reference symbols l, m, and n used in the formula (1) will be explained. Reference symbols l, m, and n represent mol % of individual structural units, that is, isocyanate compound, polymer diol compound, and chain extender, respectively, and thus represents the composition of a polyurethane serving as a leukocyte adsorbing material.

By controlling the value of l/(m+n), that is, a value obtained by dividing the mol % of a diisocyanate compound structural unit by the total of the mol % of a polymer diol compound structural unit plus the mol % of a chain extender structural unit, the weight-average molecular weight of a polyurethane according to the present invention and the functional group positioned at the end of the polymer can be selected. For example, in order to obtain a polyurethane having a necessary and sufficient weight-average molecular weight and a hydroxyl group positioned at the end of the polymer, the l/(m+n) value must be 0.9 or more. Furthermore, in order to obtain a polyurethane having a necessary and sufficient weight-average molecular weight and an isocyanate group positioned at the end of the polymer, the l/(m+n) value must be 1.25 or less. More desirably, the l/(m+n) value is equal to or more than 0.95 and not more than 1.1. If the value falls within this range, the weight-average molecular weight and the functional group positioned at the end of a polymer can be most easily controlled.

The value n, which represents the mol % of a chain extender structural unit, is desirably equal to or more than 0 and not more than 40. If the value n falls within this range, a polyurethane can be sufficiently polymerized or cross-linked.

When a polyurethane used in the present invention is synthesized, an appropriate catalyst may be used in order to accelerate the synthetic reaction. Examples of such a catalyst include metal compounds such as dibutyltin dilaurate, tin octanoate, and lead naphthenate. In particular, dibutyltin dilaurate and tin octanoate are desirable. The amount of a catalyst varies depending upon the reaction composition, reaction concentration, and reaction temperature. Usually, equal to or more than 0.05% and not more than 1.00% by weight of the total amount of a diol, isocyanate and chain extender, is selected as the amount of a catalyst. If a catalyst is contained in an amount of 0.05% by weight or more, polymerization can proceed at a necessary and sufficient rate. If the amount is 1.00% or less by weight, no significant gelation will not take place. Further preferable amount of a catalyst is equal to or more than 0.10% and not more than 0.80% by weight and most preferably, equal to or more than 0.15% and not more than 0.60% by weight.

A labeled sugar chain used in the present invention is one having a site where a fluorescence-absorbing functional group is present, which enables to quantify the sugar chain based on fluorescence absorption. Specific examples of such a labeled sugar chain include Neu5Ac.2-3Gal.1-4GlcNAc-PF (manufactured by Glycotech).

A labeled sugar chain solution used in the present invention is produced by dissolving the aforementioned labeled sugar chain in a phosphate buffer in an appropriate concentration.

The LDF1 used in the present invention refers to a labeled sugar chain solution having a concentration of 25 μg/10⁻⁶ m³ prepared by using 0.01 M phosphate buffer (pH 7.4).

The interaction between a labeled sugar chain and the surface of a polyurethane used in the present invention may be assessed efficiently by a microarray evaluation method.

Such a microarray evaluation method used herein assesses the various adsorption characteristics of a synthetic polymer in accordance with a manner of combinatorial chemistry.

In the present invention, the adsorption amount of LDF1 must be 400,000 or more as expressed by the fluorescent intensity. If the adsorption amount is 400,000 or more, a polyurethane exhibits sufficient leukocyte removing capability when it is applied to a leukocyte-removing filter coating agent as a leukocyte adsorbing material; in this case the leakage of blood platelets is small. Such a polyurethane is advantageous because it exhibits constant results in many blood samples collected from different donors. More preferably, the adsorption amount of LDF1 is 600,000 or more, and most preferably, 800,000 or more.

The leukocyte adsorbing material composed of a polyurethane according to the present invention may be formed in a single formed body or a composite formed of a water insoluble carrier and a polyurethane attached thereto by coating and a graft reaction. The leukocyte adsorbing material is applied, by a known method, to medical devices and various types of laboratory instrument for medical care or medical science including a leukocyte-removing filter for blood transfusion, which requires adsorbing a large amount of leukocytes.

A material for a water insoluble carrier used in the present invention is not particularly limited as long as it is insoluble in water. However, in consideration of availability and sterilization property, examples mentioned below may be used. Examples of such a material for a water insoluble carrier include synthetic polymers such as polystyrene, polyethylene, polypropylene, polymethyl methacrylate, various (meth)acrylic based resins, nylon, polyester, polycarbonate, polysulfone, polyacrylamide, polyurethane, and polyvinylacetate; naturally-occurring polymers such as agarose, cellulose, cellulose acetate, chitin, chitosan, and alginate; inorganic materials such as hydroxyl apatite, silica, alumina, titania, glass, mica, and carbon black; metals such as stainless steel, titanium, and aluminum. Examples of the form of a carrier include mesh, woven cloth, non-woven cloth, tertiary network structure, plain board, and granular form. To these carriers, various surface treatments may be applied in order to improve the coverage. Examples of such surface treatments include chemical treatments with a silane coupling agent, acid, alkali, and an organic solvent; and physical treatments such as a plasma treatment, corona discharge, radiation irradiation, and sandblasting. The surface treatment may be appropriately selected as needed.

The present invention will be explained in more detail below by way of examples and comparative examples.

### EXAMPLES

### <Preparation for Reagent Used in Polyurethane Synthesis>

To remove the contained water from various diol compounds to be used, the diol compounds were subjected to drying treatment under a reduced pressure at a pressure of 0.133 KPa and a temperature of 60° C. for 12 hours. Also, an isocyanate compound and chain extender were subjected to a similar drying treatment under a reduced pressure at 25° C. and 0.133 KPa. Reagents were dissolved in a solvent, N-methyl-2-pyrrolidon (dehydrated product with high purity, manufactured by Sigma-Aldrich).

Next, various diol solutions were prepared by using diols and dehydrated N-methyl-2-pyrrolidone. Using a diol having a number-average molecular weight of less than 1,000, 13% by volume diol solution (containing 13 g of a diol compound per 100×10⁻⁶ m³ of the solution) was prepared. On the other hand, using a diol having a number-average molecular weight of not less than 1,000, 10% by volume diol solution was prepared. Diisocyanate was added in an N-methyl-2-pyrrolidone solution in a concentration of 20% by volume. A chain extender was prepared in a concentration of 20% by volume in the same manner. Tin octanoate serving as a catalyst was used without purification.

Diethyl ether (manufactured by Wako Pure Chemical; super-high grade) and tetrahydrofuran (manufactured by Wako Pure Chemical; super-high grade) were not purified and directly used in purification by precipitation.

### <Determination of Concentration of Hydroxyl Group in Diol Compound Solution>

The concentration of a hydroxyl group contained in a diol compound solution was determined based on the amount required for esterification of phthalic acid anhydride. In the first place, 16 g of anhydrous phthalic acid was dissolved in 1 dm³ of pyridine (Wako Pure Chemical, super-high grade). 2.5 g of imidazole (Wako Pure Chemical, super-high grade) was further added thereto, and the mixture was allowed to stand alone overnight to prepare a phthalating agent.

As a next step, 20 cm³ of the diol compound solution was taken. Then, the molar mass of a hydroxyl group present in the diol compound solution was estimated by calculation based on the number-average molecular weight and the concentration of the solution. Thereafter, the phthalating agent was added to the aforementioned diol compound solution in an amount corresponding to 1.5 times the calculation value at room temperature. The reaction was allowed to proceed well by heating the reaction mixture to 95° C.

The temperature of the reaction mixture was reduced to room temperature, and 5 cm³ of distilled water was added thereto. In this way, the reaction of unreacted anhydrous phthalic acid was allowed to proceed well. The reaction mixture was tiltrated with 0.5N sodium hydroxide solution using phenolphthalein as an indicator. The amount of anhydrous phthalic acid reacting with the diol compound was determined based on the tiltration amount, and then, the amount of hydroxide group in the diol compound solution was determined.

### <Determination of Concentration of Isocyanate Group in Diisocyanate Compound Solution>

The concentration of an isocyanate group in a diisocyanate compound solution was determined by reacting a diisocyanate compound with a predetermined amount of dibutyl amine and tiltrating unreacted dibutyl amine. First, 0.5 cm³ of a toluene solution of an isocyanate compound was taken. Subsequently, the molar mass of an isocyanate compound in the isocyanate compound solution was determined by calculation based on the molecular weight of the isocyanate compound and the concentration of the isocyanate compound solution. Dibutyl amine was added to the toluene solution in an amount corresponding to 1.5 times the calculation value and allowed to react well. Subsequently, the reaction mixture was tiltrated with 0.02N hydrochloric acid methanol solution using bromophenol as an indicator. Based on the tiltration amount, the remaining dibutyl amine was quantified, and then, the amount of dibutyl amine required for the reaction was determined. In this way, the amount of an isocyanate group contained in the isocyanate compound solution was determined.

### <Measurement by Gel Permeation Chromatography (GPC)>

The molecular amounts and molecular-amount distributions of synthesized polyurethane and an aliquot of polyurethane taken from the reaction system were determined by using a HP1090 type apparatus (manufactured by Hewlett Packard) equipped with a column (PLgel, Mixed-C, 300×75 mm) manufactured by Polymer Laboratories. The measurement was performed by using N-methyl-2-pyrrolydone mobile phase at a column temperature of 60° C. The molecular weight was calculated from a calibration curve which was drawn based on the elution time of poly(methyl methacrylate) used as a reference sample, in terms of the molecular weight of poly(methyl methacrylate).

### <Polymerization and Purification of Polyurethane Containing a Chain Extender>

Into a glass reactor of 50×10⁻⁶ m³, a magnetic stirrer was placed. The reactor was dried at 120° C. for 2 hours, and cooled in a dry nitrogen atmosphere. Thereafter, 0.006 g of tin octanoate serving as a catalyst was added thereto in a dry nitrogen atmosphere.

An aliquot of 10×10⁻⁶ m³ was taken from the aforementioned diol compound solution (the concentration of a hydroxyl group was previously determined) by a glass syringe which was completely dried, and it was added to the reactor, and mixed with the catalyst while stirring in a dry nitrogen atmosphere.

The reaction was performed in two steps. First, polyurethane was polymerized in a general manner. Based on the amount of a hydroxyl group present in 10×10⁻⁶ m³ of the diol compound solution, the amount of the diisocyanate compound solution was calculated. The diisocyanate compound solution was taken by a dried glass syringe similarly to the case of the diol compound solution, and was gradually added dropwise to the reactor at 25° C. When the reaction started and heat generated, a polymerization vessel was maintained at 60° C. and polymerization was continued for 90 minutes. At this time point, a small amount of reaction product was taken out from the reaction system by a dried glass syringe, and then the amount of an isocyanate group was quantified by tiltration with dibutyl amine. When the amount of the remaining isocyanate group, which was calculated from the amounts of a starting diol compound and a starting isocyanate compound, reached a theoretical value, it was judged that the first reaction was completed. Then, the reaction temperature was reduced to 30° C.

In the subsequent second-step reaction, the amount of a reactive functional group in the chain extender was calculated based on the amount of the remaining isocyanate group unreacted after the first-step reaction. Subsequently, a predetermined amount of the chain extender shown in Table 1 was added to the reactor, and the temperature of the reactor was maintained at 75° C. An aliquot of the reaction product was appropriately taken by a dried glass syringe, and the molecular weight of the reaction product was determined by the gel permeation column (GPC) method. At the time the molecular weight of a peak was no longer increased, it was judged that the reaction was completed.

### <Polymerization and Purification of Polyurethane Containing No Chain Extender>

Into a glass reactor of 50×10⁻⁶ m³, a magnetic stirrer was placed. The reactor was dried at 120° C. for 2 hours, and was cooled in a dry nitrogen atmosphere. Thereafter, 0.006 g of tin octanoate serving as a catalyst was added thereto in a dry nitrogen atmosphere.

An aliquot of 10×10⁻⁶ m³ was taken from the diol compound solution (the concentration of a hydroxyl group was previously determined) by a completely dried glass syringe, and it was added to the reactor and mixed well with the catalyst while stirring in a dry nitrogen atmosphere.

Based on the amount of a hydroxyl group present in 10×10⁻⁶ m³ of the diol compound solution, the amount of the diisocyanate compound solution of interest was calculated. The diisocyanate compound solution was taken by a well-dried syringe similarly to the case of the diol compound solution, and was gradually added dropwise to the reactor at 25° C. When the reaction started and heat generated, polymerization vessel was maintained at 60° C. and polymerization was continued for 90 minutes. Thereafter, the polymerization vessel was cooled to 25° C.

After completion of the reaction, a glass beaker of 1000×10⁻⁶ m³ containing 400×10⁻⁶ m³ of diethylether was prepared. The reaction product was gradually poured in the glass beaker while stirring, and was allowed to stand for 3 hours. After polyurethane was allowed to precipitate well, most of diethylether was removed by decantation. Subsequently, 50×10⁻⁶ m³ of tetrahedrofuran was added to re-dissolve the polymer (polyurethane) synthesized. This dissolved polymer solution was gradually poured into 400×10⁻⁶ m³ of diethylether. After a sufficient amount of polyurethane was precipitated, the precipitated polymer was placed in a glass Petri dish of 0.1 m in diameter, and was subjected to a drying treatment under reduced pressure at 50° C. and 0.133 KPa for 24 hours. In this manner, the residual solvent and monomers were completely removed.

### <Microarray Analysis>

The adsorption interaction between the polyurethane according to the present invention and LDF1 was determined in accordance with the following microarray analysis.

On the surface of a class plate of 75×10⁻³ m in length and 25×10⁻³ m in width, a gold deposition film of 3000 nm in thickness was previously formed by a vacuum evaporation device, CFS-8EP-55 (manufactured by Shibaura). Sample polymers and reference samples, namely, a vinylidene chloride/acrylonitrile copolymer and poly (n-butyl methacrylate), which were selected from a polymer sample kit #205 (manufactured by Scientific Polymer Products), were dissolved in N-methyl-2-pyrrolidon in a concentration of 10 g/dm³ to obtain individual polymer solutions. The polymer solutions were added to a 384-well polypropylene plate (manufactured by Genetix).

On the glass place having a gold deposition film coated on the surface, a sample polymer solution and a reference polymer solution were dropped by means of an arrayer device, Q Array mini (manufactured by Genetix). More specifically, a sample polymer solution was dropped 5 times by using a standard solid (no hollow) pin of 150 μM (manufactured by Genetix) to form 4 spots in total. After a series of sample polymer solutions were dropped to form respective spots, the pins used in the spot formation were washed well with ethanol vapor, and were dried with compression air.

Furthermore, 4 spots for each of all polymer solutions were formed on the glass plate having a gold deposition film on the surface by repeating the aforementioned method.

To remove the remaining solvent, each glass plate was placed in a vacuum dryer and dried at 50° C. for 16 hours. In this way, glass plates for analysis each having 4 spots of a sample polymer, were obtained. Since a single glass plate for analysis is required for every analysis different in adsorption time, many identical plates were prepared as needed for monitoring the adsorption amount with time.

On the glass plate for analysis, a frame “Gene Frame” (manufactured by AB gene) was placed and LDF 1 was added thereto, and it was covered with a polyester sheet (manufactured by AB gene), and was allowed to stand still for 5 minutes for exposing the sample to LDF1. After the plastic (polyester sheet) cover and subsequently the frame were removed, the resultant glass plate was washed with deionized water, 0.01M phosphate buffer solution (pH7.4) and deionized water successively in this order, followed by being dried with nitrogen gas at room temperature. As a result, a glass plate for 5-minute exposure analysis was obtained. Similarly, a sample polymer plate was allowed to stand for 120 minutes to expose to LDF1 and subjected to the same treatment. In this way, a glass plate for 120-minute exposure analysis was obtained.

The fluorescent intensity of a labeled sugar chain adsorbed to a polymer spot placed on each of the 5-minute exposure and 120-minute exposure glass plates was measured by a fluorescence analysis device, Bioanalyser 4f/4s scanner (manufactured by LaVision BioTech). The measurement data of the fluorescent intensity was appropriately analyzed by the analysis/calculation software, FIPS software (manufactured by LaVision Biotech).

### <Analysis Using Blood>

Analysis using blood was carried out as follows using the synthesized polyurethane compounds according to the present invention. 0.20 g of a polyurethane compound according to the present invention was dissolved in 9.8 g of a mixed solvent of 70% by weight of tetrahydrofuran and 30% by weight of methanol to prepare 10 g of 2.0% by weight coating solution.

In the coating solution, non-woven cloth (40 g/m² of mass per unit area, 200 μm in thickness, and 0.15 m in width), which was formed of polyethylene terephthalate fibers having an average fiber diameter of 1.2 μm, was soaked continuously and allowed to pass between the rolls of a nip roller to remove an excessive coating solution. The coated non-woven cloth was dried at 40° C. for 10 minutes in a dry room equipped with an exhaust duct, and was then recovered.

From the coating non-woven cloth thus manufactured, disk-form pieces of 0.02 m in diameter were cut away. Nine disk-form pieces were packed in an appropriate filter holder at a packing density of 0.2 g×10⁻⁶ m³, thereby preparing a blood-analysis column.

Subsequently, blood for use in analysis was prepared as follows. First, blood (200 cm³) for use in analysis was taken from donors by means of an automatic blood collection device, HEMO-QUIC AC-183 (manufactured by Terumo) and stored in a transfusion pack. To 100×10⁻⁶ m³ of the thus collected blood, 14×10⁻⁶ m³ of a filtrated CPD solution (prepared by dissolving 26.3 g of trisodium citrate dihydrates, 3.27 g of citric acid monohydrate, 23.2 g of glucose, and 2.51 g of sodium dihydrogen phosphate dihydrate in 1 L of distilled water of an injection grade, and filtrating the solution through a filter of 0.2 μm in diameter) was added and mixed as an anti-coagulant. The blood for analysis was stored at 20° C. for 3 hours. Hereinafter, the blood thus prepared will be referred to as “human flesh whole blood”.

The human flesh whole blood was transferred from the transfusion blood storage bag to a syringe of 20×10⁻⁶ m³ (manufactured by Terumo) and allowed to flow at a constant rate of 0.74×10⁻⁶ m³/minute by means of a syringe pump (manufactured by Terumo: TE-311), and blood of 4×10⁻⁶ m³ was collected.

An aliquot was taken in a predetermined amount from each of the flesh whole blood samples before and after filtration, and the concentration of leukocytes was determined by means of a residual leukocyte determination reagent system, LeucoCOUNT™ kit, flow cytometer, FACSCalibur and analytic software CELL Quest (all above were manufactured by BD Bioscience, USA). The concentration of blood platelets was determined by an automatic hemacytometer, MAX A/L-Retic (manufactured by BECKMAN COULTER, USA).

Based on the concentrations of leukocytes contained in human flesh whole blood before and after the filtration, leukocyte removing capability and blood platelet leakage percentage were respectively calculated by using the equations (a) and (b) below.

Leukocyte removing capability (−Log)=−Log(leukocyte concentration in recovered blood after filtration/leukocyte concentration in human flesh whole blood) (a)

Blood platelet leakage percentage (%)=blood platelet concentration in recovered blood after filtration/blood platelet concentration in whole blood before filtration)×100 (b)

### Example 1

As shown in Table 1, by using 10% by volume diol compound solution of polytetramethylene glycol (PTMG) having a number-average molecular weight of 1,000, 20% by volume isocyanate compound solution of hexamethylene diisocyanate (HDI), and 20% by volume chain extender solution of 3-(dimethylethylamino)-1,2-propandiol (DMAP), polymerization and purification were performed in accordance with the aforementioned “polymerization and purification of polyurethane containing a chain extender”.

The molecular weight was determined in accordance of gel permeation chromatography (GPC). The results are summarized in Table 1.

The microarray measurement was performed in accordance with the aforementioned microarray analysis. Spots of polymers of Examples 1, 2, 3 and Comparative Examples 1, 2, 3, 4 were formed on the same glass plate for analysis. The results of analysis are shown in Table 1. The fluorescence adsorption amounts, which represents LDF1 adsorption amounts of a vinylidene chloride/acrylonitrile copolymer and poly (n-butyl methacrylate) serving as reference samples, after two hour exposure, were 421,428 and 53,772, respectively.

Blood was analyzed in accordance with the aforementioned analysis method using blood. The polymer spot solutions of Examples 1, 2, 3 and Comparative Examples 1, 2, 3, 4 and 5 were analyzed by using human flesh whole blood obtained from the same blood donor. The results of analysis are shown in Table 1.

### Example 2

As shown in Table 1, using 13% by volume diol compound solution of PTMG having a number-average molecular weight of 250, 20% by volume an isocyanate compound solution of HDI, and 20% by volume chain extender solution of DMAPD, polymerization and purification were performed in accordance with the aforementioned “polymerization and purification of polyurethane containing a chain extender”.

Gel permeation chromatography (GPC), microarray determination, and analysis using blood were performed in the same manner as in Example 1.

### Example 3

As shown in Table 1, using 10% by volume diol compound solution of PTMG having a number-average molecular weight of 1,000, 20% by volume an isocyanate compound solution of 1,3-bis(isocyanate methyl)cyclohexane (BICH), and 20% by volume chain extender solution of 2,2,3,3,4,4,5,5-octafuluoro-1,6-hexane diol (OFID), polymerization and purification were performed in accordance with the aforementioned “polymerization and purification of polyurethane containing a chain extender”.

Gel permeation chromatography (GPC), microarray determination, and analysis using blood were performed in the same manner as in Example 1.

### Comparative Example 1

As shown in Table 1, using 13% by volume diol compound solution of PTMG having a number-average molecular weight of 650, 20% by volume isocyanate compound solution of 4,4-methylenebis(phenyl)socyanate) (MDI), and 20% by volume chain extender solution of 3-(diethylethylamino)-1,2-propandiol (DEAPD), polymerization and purification were performed in accordance with the aforementioned “polymerization and purification of polyurethane containing a chain extender”.

Gel permeation chromatography (GPC), microarray determination, and analysis using blood were performed in the same manner as in Example 1.

### Comparative Example 2

As shown in Table 1, using 13% by volume diol compound solution of polyethylene glycol (PEG) having a number-average molecular weight of 400, and 20% by volume isocyanate compound solution of MDI, polymerization and purification were performed in accordance with the aforementioned “polymerization and purification of polyurethane containing no chain extender”.

Gel permeation chromatography (GPC), microarray determination, and analysis using blood were performed in the same manner as in Example 1.

### Comparative Example 3

As shown in Table 1, using 10% by volume diol compound solution of polypropylene glycol (PPG) having a number-average molecular weight of 2,000, 20% by volume isocyanate compound solution of MDI, and 20% by volume chain extender solution of DMAPD, polymerization and purification were performed in accordance with the aforementioned “polymerization and purification of polyurethane containing a chain extender”.

Gel permeation chromatography (GPC), microarray determination, and analysis using blood were performed in the same manner as in Example 1.

### Comparative Example 4

As shown in Table 1, using 10% by volume diol compound solution of polypropylene glycol (PPG) having a number-average molecular weight of 425, 20% by volume isocyanate compound solution of MDI, and 20% by volume chain extender solution of DMAPD, polymerization and purification were performed in accordance with the aforementioned “polymerization and purification of polyurethane containing a chain extender”.

Gel permeation chromatography (GPC), microarray determination, and analysis using blood were performed in the same manner as in Example 1.

### Comparative Example 5

A leukocyte removing filter, RS-2000 (manufactured by Asahi Medical) was made into pieces, and the non-woven cloth used therein was picked up. From the non-woven cloth thus picked up, disk-form pieces of 0.02 m in diameter were cut away. Nine disk-form pieces were packed into the same filter holder used in Examples and Comparative Examples at a packing density of 0.2 g×10⁻⁶ m³. In this way, a blood-analysis column was prepared.

The samples of Examples and Comparative Examples were subjected to analysis of blood. The results are shown in Table 1.

TABLE 1
Synthesis condition, results of microarray analysis and blood test

| | | | Example | Example | Example | Comparative | Comparative | Comparative | Comparative | Comparative |
|---|---|---|---|---|---|---|---|---|---|---|
| | | | 1 | 2 | 3 | Example 1 | Example 2 | Example 3 | Example 4 | Example 5 |
| Starting | Diol | Name | PTMG | PTMG | PTMG | PTMG | PEG | PPG | PPG | |
| material | compound | Mn | 1000 | 250 | 1000 | 650 | 400 | 2000 | 425 | |
| | Isocyanate compound | | HDI | HDI | BICH | MDI | MDI | MDI | MDI | |
| | Chain extender | | DMAPD | DMAPD | OFHD | DEAPD | none | DMAPD | DMAPD | |
| | Starting | Diol | 1.00 | 1.30 | 1.00 | 1.30 | 1.30 | 1.00 | 1.30 | |
| | amount/g | compound | | | | | | | | |
| | | Isocyanate | 0.36 | 1.26 | 0.59 | 1.04 | 0.88 | 0.28 | 1.59 | |
| | | compound | | | | | | | | |
| | | Chain | 0.23 | 0.57 | 0.50 | 0.27 | 0.00 | 0.05 | 0.34 | |
| | | extender | | | | | | | | |
| | | Tin | 0.005 | 0.006 | 0.006 | 0.006 | 0.006 | 0.006 | 0.005 | |
| | | octanoate | | | | | | | | |
| Polymer | Composition | Diol | 0.17 | 0.25 | 0.17 | 0.25 | 48.5 | 0.25 | 0.25 | |
| structure | mol ratio | compound | | | | | | | | |
| | | Isocyanate | 0.52 | 0.52 | 0.52 | 0.52 | 51.5 | 0.52 | 0.52 | |
| | | compound | | | | | | | | |
| | | Chain | 0.33 | 0.23 | 0.33 | 0.23 | 0 | 0.23 | 0.23 | |
| | | extender | | | | | | | | |
| | Molecular | Mw | 42000 | 69000 | 40000 | 84000 | 18000 | 42000 | 23000 | |
| | weight | Mn | 23000 | 36000 | 23000 | 36000 | 10500 | 24000 | 12000 | |
| | | Mw/Mn | 1.8 | 1.8 | 1.7 | 2.2 | 1.7 | 1.8 | 1.9 | |
| Biocom- | Microarrary | 5 min | 288773 | 289436 | 377644 | 156489 | 159014 | 43209 | 77273 | Nonwoven |
| patibility | determination | 2 hr | 982146 | 642391 | 453350 | 311712 | 282760 | 100000 | 87519 | cloth coated |
| test | | 2 hr/ | 3.4 | 2.2 | 1.2 | 2.0 | 1.8 | 2.3 | 1.1 | with |
| | | 5 min | | | | | | | | RS-2000 |
| | | | | | | | | | | (product |
| | | | | | | | | | | name) |
| | Blood test | Leukocyte | 3.26 | 3.00 | 2.76 | 2.54 | 2.61 | 2.60 | 2.58 | 2.73 |
| | | removing | | | | | | | | |
| | | capability | | | | | | | | |
| | | Blood | 0.0 | 0.5 | 0.,6 | 0.7 | 22.3 | 34.7 | 4.2 | 1.2 |
| | | platelet | | | | | | | | |
| | | leakage | | | | | | | | |
| | | percentage | | | | | | | | |
| | | (%) | | | | | | | | |

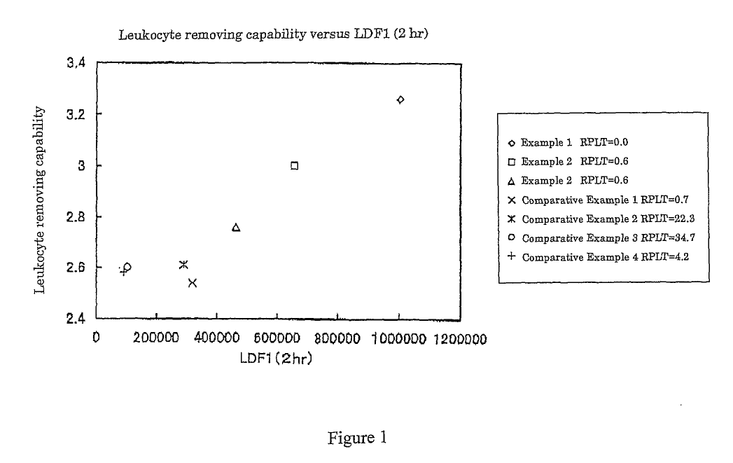

As is apparent from FIG. 1, LDF1 adsorption amount in terms of the fluorescent intensity has a proportional relationship with leukocyte removing capability. In other words, it is clear that the leukocyte removing capability increases as the LDF1 adsorption amount increases. In particular, a polyurethane compound within the range of present invention, that is, having an LDF1 adsorption amount of 400,000 or more, has excellent leukocyte-removing capability. Since LDF1 shows a strong interaction with leukocytes, the molecular structure adsorbing a large amount of LDF1 may be considered to have an excellent leukocyte removing capability. From the comparison with Comparative Example 5, it is found that any of the polyurethane filters of Examples 1, 2, and 3 has a leukocyte adsorption capacity higher than a commercially available product. Based on the above, as long as any common polyurethane whose leukocyte adsorption capacity may be low, satisfies the range of the present invention, it may be considered to have a substantially satisfactory leukocyte removing capability.

As is apparent from blood platelet leakage percentage (R. PLT) of the column of “analysis using blood” of the Table 1, a polymer structure exhibiting a high LDF1 adsorption capacity represented by the fluorescent intensity has a low R.PLT. In general, it is desired that the leukocyte removing filter should have a low R.PLT. The polyurethane of the present invention satisfies this feature, since it has an LDF1 adsorption amount as high as 400,000 or more. Therefore, the polyurethane of the present invention can be suitably applied to a leukocyte-removing filter.

The relationship between a chemical structure, LDF1 adsorption amount, and leukocyte removing capability is clearly shown in Table 1. In considering a chemical structure, PTMG is preferable as a diol compound. It is presumed that a diol compound having a certain degree of hydrophobic property is desirable.

It is also found that HDI and BICH are desirable isocyanate compounds. Although it is not known exactly why, it is presumed that isocyanate compounds having an aliphatic or alicyclic structure are desirable.

As is apparent from the comparison between Examples 1, 2, 3 and Comparative Example 2, a sufficient phase-separation cannot be obtained unless a polyurethane has a weight-average molecular weight of 20,000 or more. In this case, a sufficient interaction with LDF1 and a sufficient leukocyte removing capability can not be achieved.

### ADVANTAGES OF THE INVENTION

According to the present invention, a polyurethane material having an excellent leukocyte adsorption capacity can be provided.

1. A leukocyte adsorbing material comprising a polyurethane, wherein the polyurethane is represented by the following formula (1):
[AₗBₘCₙ] (1)
wherein (A), (B) and (C) are structural units which constitute the polyurethane, in which
(A) is a structural unit derived from an aliphatic or alicycle diisocyantate compound,
(B) is a structural unit derived from a diol compound, and
(C) is a structural unit derived from a chain extender compound,
with the provisio that the weight-average molecular weight of the polyurethane is more than 20,000 and not more than 1,000,000; and
l, m and n represent mol % of the structural units (A), (B), and (C), respectively, and satisfy the relations
l+m+n=100
0.9≦l/(m+n)≦1.25, and
0≦n≦40

2. The leukocyte adsorbing material according to claim 1 wherein the diol compound structural unit is derived from a polymeric diol compound.

3. The leukocyte adsorbing material according to claim 2 wherein the polymeric diol compound has a molecular weight equal to or more than 200 and not more than 10,000.

4. The leukocyte adsorbing material according to claim 1 wherein the chain extender compound is a compound having two or more

4. The leukocyte adsorbing material according to claim 1 wherein the chain extender compound is a compound having two or more hydroxyl, amino and/or mercapto groups reactable with isocyanate groups, and containing one or more tertiary amino groups.

5. The leukocyte adsorbing material according to claim 4 wherein n>0.

6. The leukocyte adsorbing material according to claim 1 wherein the diisocyanate compound structural unit is derived from hexamethylene diisocyanate and/or 1,3-bis(isocyanatemethyl)cyclohexane.

7. The leukocyte adsorbing material according to claim 1 which exhibits and adsorption amount of 400,000 or more after being exposed to a labeled sugar chain solution (LDF1) for 2 hours.

8. A leukocyte adsorbing material composed of polyurethane which exhibits an adsorption amount of 400,000 or more after being exposed to a labeled sugar chain solution (LDF1) for 2 hours.

9. A method of screening polymers for leukocyte adsorbing properties which comprised exposing the polymers to a labelled sugar chain solution (LDF1) for 2 hours and identifying the polymers which exhibit an adsorption amount of 400,000 or more.

10. The method according to claim 9 in which the polymers are screened as an array of polymer samples and effective polymers are identified by measuring fluorescence of the labelled sugar adsorbed to the samples.

11. The method according the claim 9 in which the polymers are polyurethanes.
